(19) United States
(12) Patent Application Publication
(10) Pub. No.: US 2024/0248537 A1
(43) Pub. Date: Jul. 25, 2024

(54) SYSTEM AND METHOD FOR ENABLING A MULTI-OPERATOR EDGE ENVIRONMENT

(71) Applicant: INDIAN INSTITUTE OF TECHNOLOGY DELHI, New Delhi (IN)

(72) Inventors: Brejesh LALL, New Delhi (IN); Ashish Singh PATEL, New Delhi (IN); Gaurav SHUKLA, New Delhi (IN); Arzad Alam KHERANI, New Delhi (IN)

(21) Appl. No.: 18/472,485

(22) Filed: Sep. 22, 2023

(30) Foreign Application Priority Data
Jan. 25, 2023 (IN) 202311005152

(51) Int. Cl. G06F 3/01; H04L 67/1061; H04L 67/60

(52) U.S. Cl. CPC G06F 3/016; H04L 67/1061; H04L 67/60

(57) ABSTRACT

The present invention relates to a system and method for enabling a multi-operator edge environment. The present invention provides an architecture that caters to broad application support (software and hardware support) from multiple EDNs supported by other Edge Service Providers. Further, the architecture of the present invention is based on the 3GPP app enablement architecture that is flexible to incorporate, manage, and cooperate with multiple ESP(s). The developed architecture has several new entities and interfaces to support the multiple ESP. The architecture further includes Federated Edge Configuration Server (F-ECS).

### CROSS-REFERENCE TO RELATED APPLICATION(S)

This application claims priority from Indian application Ser. No. 202311005152 filed Jan. 25, 2023, which is incorporated herein by reference in its entirety.

### TECHNICAL FIELD

The present invention relates to a system and method for enabling a multi-operator edge environment. Particularly, the present invention relates to robotics i.e., a remote robot control with a multi-operator edge over 5G and beyond.

### RELATED ART

Remote robots having wide use-cases in healthcare, industrial automation, and gaming are a boon to commercial applications. The inclusion of AR/VR technologies led to a new pathway for digital twins and Tactile Internet. These use-cases (i.e. Digital Twins, AR/VR, and Tactile Internet) require communication with ultra-low latency with high availability while ensuring reliability and security. The advent of the 5G network sufficiently ensures Ultra-Reliable Low Latency communications while offering flexibility.

The ultra-low latency and high bandwidth that 5G brings is crucial in enabling the use of AR/VR. For many industrial and enterprises customers, private 5G solutions ensure that the applications receive the capabilities required to carry out mission critical processes, where public 5G networks either do not extend sufficient coverage or do not deliver a specific capability to the required level or are deemed not secure enough. Private 5G networks are networks owned by and dedicated to a private party and fully operated within the site of the party, this has benefits for security, latency, bandwidth and other areas. The move to the edge means that images can be rendered much closer to the end-user (compared to the cloud) hence further enhancing the use cases. For AR/VR and the associated use cases, ultra-low latency and high bandwidth are so crucial that private 5G and edge computing are more necessary than for many other 5G-enabled use cases.

It involves extremely low latency in combination with high availability, reliability and security. Emerging Tactile Internet application fields are progressing towards precise human-to-machine and machine-to-machine interaction, with key examples found in industry, robotics and telepresence, virtual reality, augmented reality, healthcare, road traffic, serious gaming, education and culture, and smart grid. 1-millisecond end-to-end latency is necessary in Tactile Internet applications. For technical systems to match humans' interaction with their environment, our natural reaction times sets the targets that technical specifications must meet.

Furthermore, the 5G network is integrated with a high-performance computing facility at the network edge to reduce overall latency and preserve bandwidth. Edge computing plays a vital role by offering computation capabilities to the end devices at the nearest Edge and reducing latency constraints over the backhaul network. Furthermore, tactile applications can be supported with AI inferencing to meet the low latency constraints of Tactile applications. Therefore, the 5G infrastructure's high-performance computing at the Edge makes it a preferred choice for deploying haptic/tactile at Edge.

A haptic application involves a robotic end device that sends haptic feedback and a controller device that sends the control signal connected with a system. A wired or wireless network may support such a system. A Haptic system is supported with multi-modal data comprising:
(a) haptic control stream: carrying command queries from the user to the remote haptic equipment,
(b) haptic feedback stream: carrying sensor data and response queries from the remote haptic equipment back to the user,
(c) video stream: carrying an encoded video stream from the remote robot environment back to the user. Further, depending on the resolution of the video, this stream usually occupies the highest percentage of the bandwidth of the communicational channel; and
(d) audio stream: the audio stream carries audio data from the remote environment back to the user.

These streams of data get aggregated and are served as the end device (RH). As the haptic application requires dedicated hardware and software support, all ESP(s) may not be able to offer such requirements.

The current edge system lacks the architecture to manage the multi-operator edge environment. Further, not all the edge computing operators provide the services required for the tactile applications such as remote tele-surgery and provide broad application support while establishing the service level agreements with the operators. The existing architecture does not support cooperation between multiple ESP(s). The current system lack the entities and interfaces necessary to enable multi-operator edge environment.

Haptics system requires specific critical application requirements, which Edge service provider cannot provide because of infrastructure, financial and other issues. Therefore, it is imperative to have an architecture that caters to broad application support (software and hardware support) from multiple Edge Data Networks (EDNs) supported by other Edge Service Providers (ESPs).

Therefore, in view of the problem associated with the state of the art there is a need of system having remote robot control with a multi-operator edge over 5G and beyond. Further, there is a need of a controller that may be deployed at the Edge, where the transformation and translation of the haptic signals are performed.

### SUMMARY

The primary objective of the present invention is to provide a system and method for enabling a multi-operator edge environment.

Another objective of the present invention is to provide an architecture to manage resources provided by Edge Service Providers (ESPs), which can be used to serve a client application, henceforth providing broad application support at the Edge.

Yet another objective of the present invention is to provide a central entity that facilitates the establishment of a service level agreement for storing critical ESP (s) information about the services and resource availability.

Other objects and advantages of the present invention will become apparent from the following description taken in connection with the accompanying drawings, wherein, by way of illustration and example, the aspects of the present invention are disclosed.

The present invention relates to a system and method for enabling a multi-operator edge environment. The present invention provides an architecture based on the 3GPP app being flexible to incorporate, manage, and cooperate with multiple ESP (s). The architecture of the present invention has several new entities and interfaces to support the multiple ESP. The architecture involves Federated Edge Configuration Server (F-ECS). An Edge Service Provider (ESP) may need not provide all the information about the Edge Data Network (EDN) to F-ECS but exposes the services available at an EDN to the F-ECS. This will be decided at the federation and facilitate establishing service level agreement. Furthermore, if multiple ESP(s) are available for a service, then an ESP based on the application KPIs and cost-effectiveness is selected.

### BRIEF DESCRIPTION OF THE DRAWINGS

An understanding of the present invention may be obtained by reference to the accompanying drawings, when taken in conjunction with the description herein and in which:

FIG. 1 illustrates Tele-operation use case involving remote robot control and multi-operator edge;

FIG. 2 illustrates Multi-operator edge with baseline as 3GPP application enablement architecture;

FIG. 3 illustrates block diagram representing multi-operator edge support with ESP(s) from the plurality of ECS;

FIG. 4 illustrates flowchart for the working of components shown in FIG. 3; and

FIG. 5 illustrates flowchart for the working of multi-operator edge.

### DETAILED DESCRIPTION

The following description describes various features and functions of the disclosed system with reference to the accompanying figures. In the figures, similar symbols identify similar components, unless context dictates otherwise. The illustrative aspects described herein are not meant to be limiting. It may be readily understood that certain aspects of the disclosed system can be arranged and combined in a wide variety of different configurations, all of which have not been contemplated herein.

Accordingly, those of ordinary skill in the art will recognize that various changes and modifications of the embodiments described herein can be made without departing from the scope of invention. In addition, descriptions of well-known functions and constructions are omitted for clarity and conciseness.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings, but, are merely used to enable a clear and consistent understanding of the invention. Accordingly, it should be apparent to those skilled in the art that the following description of exemplary embodiments of the present invention are provided for illustrative purpose only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

The system of the present invention includes the deployment of a haptic application in an edge computing environment. The edge environment with multi-operator functionality is managed through Federated Edge Configuration Server (F-ECS), which performs the discovery and selection of the Edge Configuration Server (ECS) from one of the Edge Service Provider (ESP) based on the application characteristics and operator policy. A plurality of application client (AC) that are not able to connect with the same Edge Service Provider (ESP) may request for another ESP with a service level agreement at F-ECS. Application client is the application residing in the UE, which acts as a client function. It is connected to edge enabler client (EEC) with an edge-5 interface. The edge enabler client (EEC) connects to the edge configuration server (ECS). The address of ECS is either pre-configured in the EEC and is provided by 5G Core for initial provisioning. It provides edge configuration information to edge enabler client EEC to distinguish amongst the EESs (e.g., EDN service area); and the information for establishing a connection with EESs (such as URI). The edge configuration server ECS can be deployed in the MNO domain or can be deployed in 3^{rd} party domain by the service provider.

EES provides supporting functions needed for EASs and EEC. It exchanges application data traffic with the EAS and also triggers EAS instantiation. In the architecture of the present invention, a new entity federated edge configuration server F-ECS is introduced as a federation of all edge configuration server ECS(s), which has a service level agreement with all the edge service provider ESP(s) and can expose the services available at the EDN(s). This opens a broad application support at the Edge for any edge application server residing in EDN to act as a server. It provides benefits to avail of the services of Edge Computing.

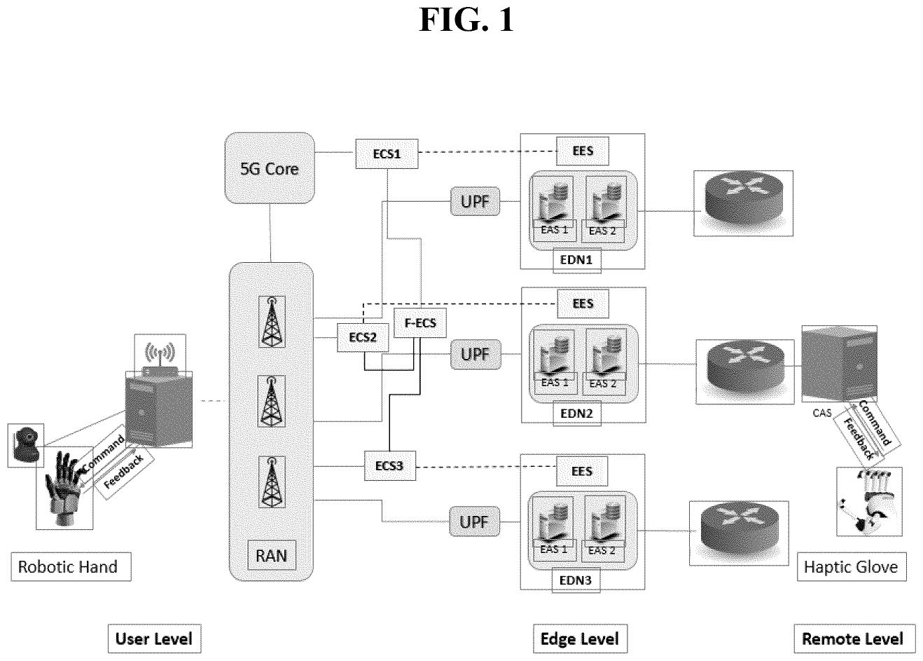

In the present invention FIG. 1 illustrates a high-level architecture of the Tele-operation use case with a multi-operator edge. The said architecture involves the deployment of a haptic application in an edge computing environment where a controller node is deployed at the Edge with the support of a multi-operator. The Robotic hand is connected to a system that connects to RAN/gNB over wifi which further connects to the mobile network. The Edge, with the support of a multi-operator, is managed by federated edge configuration server F-ECS, which has the information about the service offered by each edge service provider ESP(s) through respective ECS(s). The system with a robotic hand may be pre-configured with the address of the F-ECS or may receive it from the core network. The robotic hand connects to the haptic glove at the far through the EDN through a particular EAS. The EAS may be selected based on the application characteristics. The components of FIG. 1 are discussed in detail herein:
5G core (101)—Fifth Generation Core network
RAN (102)—radio access network (RAN) that connects individual network devices through radio connections.
3GPP core (103)—is an evolved Global System for Mobile communication (GSM) core network infrastructure.
Haptic gloves and robotic hand (104)—Gloves capable of simulating tactile sensations
Edge Configuration Server (ECS) (105): ECS provides supporting functions needed for the EEC to connect with an EES.
Federated Edge Configuration Server (F-ECS) (106)—provides exposure to the service available at EDN as well as facilitate establishing service level agreement to the UE.
User Plane Functions (UPF) (107)—represents the data plane evolution of a Control and User Plane Separation (CUPS) strategy. UPF handles Quality of Service (QoS) flows and policy enforcement acts as anchor point for NG-RAM mobility EES-Edge Enabler Server (EES). EES provides supporting functions needed for EASs and EEC-Edge Enabler Client (EEC). EEC provides supporting functions needed for AC(s).
Edge Application Server (EAS) (108): EAS is the application server resident in the EDN, performing the server functions. The AC connects to the EAS in order to avail the services of the application with the benefits of Edge Computing.

The step by step working in FIG. 1 is discussed herein in detail:
a. running application client (AC) on the user equipment (UE) is a robotic hand serving as a slave for the haptic glove located in the remote level;
b. sending the requirement of application client (AC) including the request for connecting with a specific haptic glove;
c. sending service provisioning request via user equipment (UE) to find the suitable edge application server (EAS) that serves the specific master, i.e., the haptic glove located at remote side;
d. sending service provisioning request via edge enabler client (EEC) to the ECS in order to find the suitable edge application server EAS for fulfilling the application requirement of robotic hand;
e. connecting to the federated edge configuration server F-ECS in order to find the suitable EDN, when ECS is unable to locate the suitable EDN to serve the requirements of EEC;
f. searching for a service agreement via F-ECS with other ECS provider networks, once suitable ECS is found that has the EDN information best suited for the application, the EEC is transferred to that ECS.
g. discovering the suitable EES present within the EDN information provided by the new ECS, the robotic hand sends QoS request to the EES with which the haptic hand is connected.
h. requesting quality of service (QoS) successfully, the Robotic hand successfully establishes data traffic with the haptic glove located at remote level; and
i. including robotic hand movement information along with audio and/or video as a feedback to the control signal sent by the haptic glove.

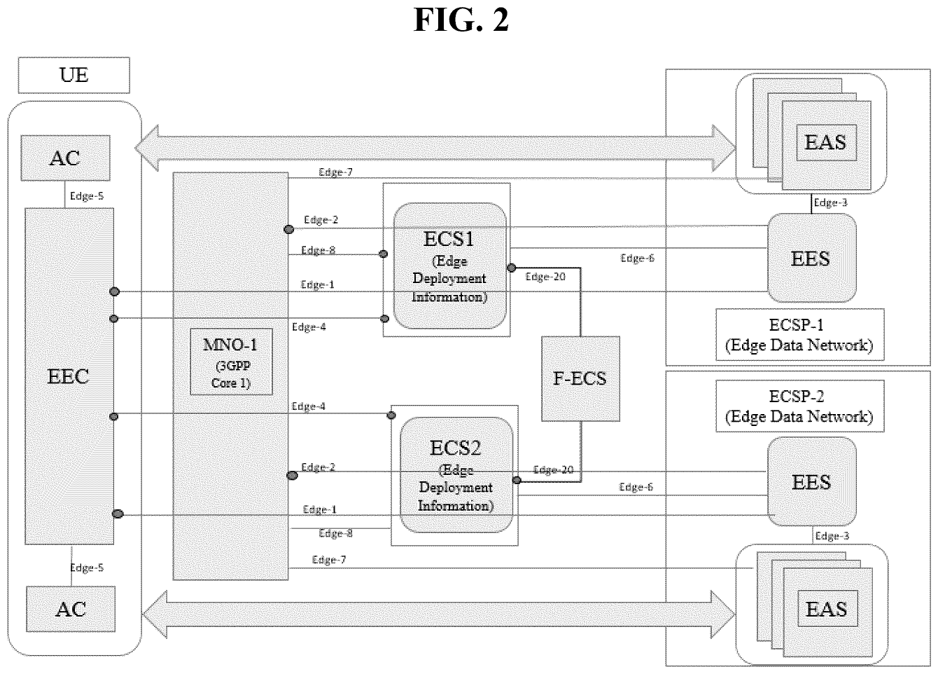

In the present invention FIG. 2 illustrates the architecture with 3GPP as the baseline. Federated edge configuration server (F-ECS), the primary entity, manages the multi-operator edge and is responsible for the discovery and selection of edge configuration server (ECS). In case the suitable edge application server (EAS) cannot be found with the pre-configured edge configuration server (ECS). An Application Client (AC) running on user equipment (UE) connects to edge configuration server (ECS) via edge enabler client (EEC) and supports Edge Enabler Server (EES's) connection and registration for EAS discovery and selection. An ESP may have a service agreement with F-ECS through which it stores the services offered and a list of supported ECS(s). An ECS which is pre-configured with the device application/EEC is selected for a preliminary connection. The ECS connects to the EES to look for an appropriate domain network EDN to serve the application at EAS. In the absence of any appropriate EAS, ECS contacts F-ECS and looks for a service agreement with other ECS Provider networks. Once the suitable serving ECS is found and discovered which can best serve the Application Client (AC), the AC is transferred to that ECS. So the newly discovered ECS connects to EES and looks for the EDN where the infrastructure to serve the AC is available.

The components of FIG. 2 are discussed herein in detail:
i. AC-Application Client (AC): AC is the application resident in the UE performing the client function.
ii. 5G core (101)—Fifth Generation Core network.
iii. Edge Configuration Server (ECS) (105): ECS provides supporting functions needed for the EEC to connect with an EES.
iv. Federated EDGE Configuration Server (FECS) (106)—Capable of exposing the service available at EDN as well as facilitate establishing service level agreement to the UE.
v. Edge Application Server (EAS) (108): EAS is the application server resident in the EDN, performing the server functions. The AC connects to the EAS to avail the services of the application with the benefits of Edge Computing.
vi. Edge Data Network (EDN)(109): It includes all the information related to EEC and EAS.
vii. Edge Enabler Client (EEC) (110): It provides supporting functions needed for AC(s)
viii. User Equipment (UE) (111): Equipment which allows a user, who is not a part of 5GS, to access to network services. It is a devices capable of supporting EEC and AC at the user end.
ix. Mobile Network Operator (MNO) (112): The operator is capable of providing wireless network services.
x. EDGE 1—reference point that enables interactions between the EES and the EEC.
xi. EDGE 2—reference point enables interactions between the EES and the 3GPP Core Network functions and APIs for retrieval of network capability information.
xii. EDGE 3—reference point that enables interactions between the EES and the EAS(s).
xiii. EDGE 4—Reference point enables interactions between the ECS and the EEC.
xiv. EDGE 6—Reference point enables interactions between the ECS and the EES.
xv. EDGE 7—Reference point enables interactions between the EAS and the 3GPP Core Network functions and APIs for retrieval of network capability information.
xvi. EDGE 8—Reference point enables interactions between the ECS and the 3GPP Core Network functions and APIs for retrieval of network capability information.
xvii. EDGE 20—Reference point enables interactions between the F-ECS and the ECS.

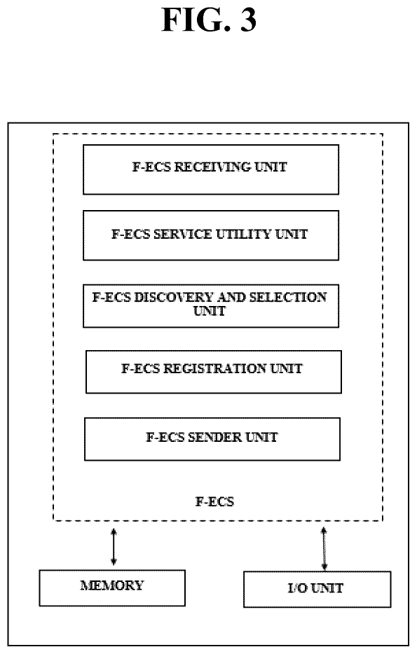

The components of the system of the present invention having multi-operator edge support with ESP(s) from the plurality of ECS as illustrated in FIG. 3 comprises:
(i) F-ECS receiving unit (113): configured to receive information from ECS for ECS discovery;
(ii) F-ECS sender unit (114): configured to response back to ECS for ECS discovery;
(iii) F-ECS service utility unit (115): configured to list services of ECS(s). F-ECS receiving unit is a system which maintains the list of services offered within the scope of a particular ECS;
(iv) F-ECS discovery and selection unit (116): for an optimal ECS selection. F-ECS discovery and selection unit performs the discovery and selection of an ECS based on the list of service offered by that particular ECS; and
(v) F-ECS registration unit (117): registering the services of ESP. Registration unit adds/delete the information about the ECS and its services when a ECS comes up or goes down

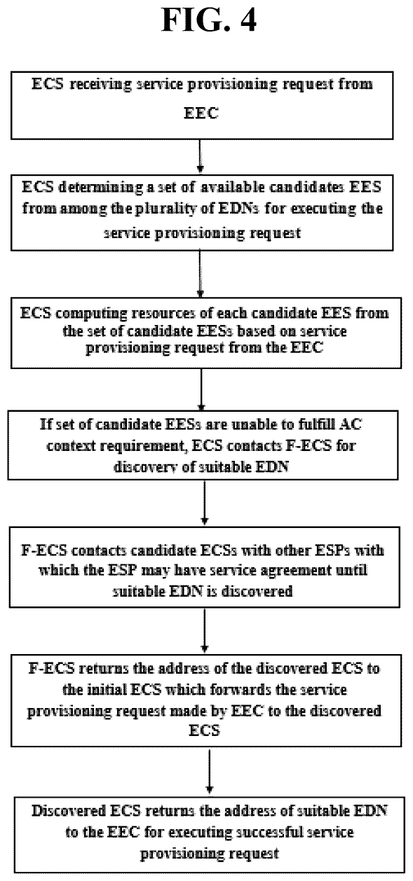

The method of working of the components discussed herein is disclosed in FIG. 4:
1. An Application Client (AC) running on UE connects to ECS via Edge Enabler Client (EEC) and sends service provisioning request for discovery of suitable EDN.
2. ECS determining a set of available candidates EES from among the plurality of EDNs for executing the service provisioning request.
3. The ECS connects to the EES to look for an appropriate domain network EDN to serve the application at EAS.
4. In the absence of any appropriate EAS, ECS contacts F-ECS for discovery of suitable EDN
5. F-ECS contacts candidate ECSs with other ESPs with which the ESP may have service agreement until suitable EDN is discovered that can fulfill AC requirements.
6. Once the suitable serving ECS is found and discovered which can best serve the Application Client (AC), the service provisioning request is transferred to that ECS.
7. So the newly discovered ECS connects EEC to the EES with suitable infrastructure to serve the AC.

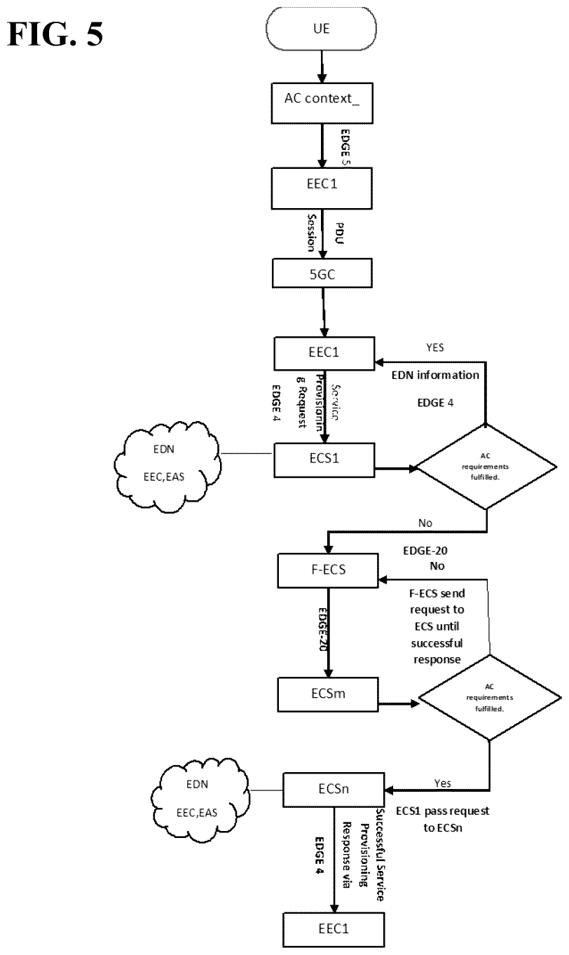

FIG. 5 illustrates the step by step working of the present invention:
1. running an Application Client (AC) on an UE and sending its application context to EEC (110) via Edge 5 to EEC1;
2. adding EEC context via EEC (110) before sending service provisioning request to the Edge Configuration Server (ECS) (105);
3. performing ECS discovery by sending data, such as AC context, EEC context etc., to the ECS (105) for service provisioning. The address of ECS is preconfigured with the EEC (110) configured by and edge-aware AC configured by the user or in the case of above flowchart, provisioned by MNO (112) through 5GC (101) procedure;
4. acquiring the address of ECS (105) and then the EEC sends service provisioning request to the ECS (105) via EDGE 4. The ECS searches for appropriate Edge Data Network (EDN) (109) in order to support the service needs of the application;
5. fulfilling the AC requirement for the ECS (105) to send appropriate EDN information to the AC;
6. contacting with Federated Edge Configuration Server (F-ECS) (106) via ECS (105) if AC requirement is not fulfilled, with which the ESP may have a service agreement and looks for service agreement with other ECS provider networks;
7. contacting other ECS (105) by the F-ECS (106) via edge-20 until suitable EDN that fulfills AC requirement is not found;
8. finding ECS (105) with suitable EDN (109), the F-ECS (106) returns the address of that ECSn to the ECS1 to which the EEC originally sent service provisioning request;
9. forwarding the service provisioning request of EEC1 to ECSn via ECS1. The ECSn sends suitable EDN information to EEC1 via EDGE 4.
10. transferring EEC (110) to a suitable ECS, the EEC (110) sends request to suitable EES within the EDN info provided by ECS via EDGE 1.
11. registering EEC (110) onto the EES, the EEC (110) sends EAS discovery request, if successful it is followed by QoS session and finally EEC is able to establish data traffic with suitable EAS to serve the needs of user application.

The advantages of the present invention are discussed herein:
The presented architecture is suitable for providing broad application support.
A central entity facilitates the establishment of a service level agreement for storing critical ESP (s) information about the services and resource availability.
The architecture supports the ESP selection based on application characteristics, application requirements, and cost-effectiveness.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

### REFERENCE NUMERALS

100 multi-operator edge environment
101 fifth generation core network
102 RAN-radio access network (RAN)
103 3GPP core
104 Haptic gloves and robotic hand
105 Edge Configuration Server (ECS)
106 Federated Edge Configuration Server (F-ECS)
107 User Plane Functions
108 Edge Application Server
109 Edge Data Network (EDN)
110 Edge Enabler Client (EEC)
111 User Equipment (UE)
112 Mobile Network Operator (MNO)
113 a F-ECS receiving unit
114 a F-ECS sender unit
115 a F-ECS service utility unit
116 a F-ECS as discovery and selection unit
117 a F-ECS registration unit

What is claimed is:

1. A system enabling multi-operator edge environment, the system comprising:
a fifth generation core network;
a RAN-radio access network (RAN) connecting individual network devices through radio connections;
a 3GPP core evolved Global System for Mobile communication (GSM) core network infrastructure;
a Haptic gloves and robotic hand providing simulation to tactile sensations;
an Edge Configuration Server (ECS) providing supporting functions needed for the EEC to connect with an EES;
a User Plane Functions (UPF) representing the data plane evolution of a Control and User Plane Separation (CUPS) strategy;
an Edge Application Server (EAS) resident in an Edge Data Network (EDN) for performing the server functions;
an Edge Data Network (EDN) including all the information related to EEC and EAS;
an Edge Enabler Client (EEC) providing supporting functions needed for AC(s);
User Equipment (UE) allowing a user, to access to network services having no access to 5GS;
a Mobile Network Operator (MNO) providing wireless network services, and
a Federated Edge Configuration Server (F-ECS) providing exposure to the service available at the EDN as well as facilitate establishing service level agreement to the UE, wherein the F-ECS comprises:
an F-ECS receiving unit configured to receive information from the ECS;
an F-ECS sender unit configured to response back to the ECS;
an F-ECS service utility unit configured to list services of the ECS(s);
an F-ECS as discovery and selection unit provides an optimal ECS selection; and
an F-ECS registration unit for registering the services of ECSP.

2. The system of claim 1, further comprising a communication interface Edge to communicate between the ECS and the F-ECS.

3. The system of claim 1, wherein the target ECS is selected based on the services required for client application.

4. The system of claim 1, wherein the communication interface Edge comprises the following reference points:
EDGE 1 reference point configured to enable interactions between the EES and the EEC;
EDGE 2 reference point configured to enable interactions between the EES and the 3GPP Core Network functions and APIs for retrieval of network capability information;
EDGE 3 reference point configured to enable interactions between the EES and the EAS(s);
EDGE 4 reference point configured to enable interactions between the ECS and the EEC;
EDGE 6 reference point configured to enable interactions between the ECS and the EES;
EDGE 7 reference point configured to enable interactions between the EAS and the 3GPP Core Network functions and APIs for retrieval of network capability information;
EDGE 8 reference point configured to enable interactions between the ECS and the 3GPP Core Network functions and APIs for retrieval of network capability information; and
EDGE 20 reference point configured to enable interactions between the F-ECS and the ECS.

5. A method for enabling multi-operator edge environment, the method comprising:
running an Application Client (AC) on an UE and sending its application context to EEC via EDGE 5 to EEC1;
adding EEC context via EEC before sending service provisioning request to the Edge Configuration Server (ECS);
performing ECS discovery by sending data, such as AC context, EEC context etc., to the ECS for service provisioning, wherein the address of ECS is preconfigured with the EEC configured by and edge-aware AC configured by the user or in the case of above flowchart, provisioned by MNO through 5GC procedure;
acquiring the address of ECS and then the EEC sends service provisioning request to the ECS via EDGE 4, wherein the ECS searches for appropriate Edge Data Network (EDN) in order to support the service needs of the application;
fulfilling the AC requirement for the ECS to send appropriate EDN information to the AC;
contacting with Federated Edge Configuration Server (F-ECS) via ECS if AC requirement is not fulfilled, with which the ESP may have a service agreement and looks for service agreement with other ECS provider networks;
contacting other ECS by the F-ECS via EDGE 20 until suitable EDN that fulfills AC requirement is not found;
finding ECS with suitable EDN, the F-ECS returns the address of that ECSn to the ECS1 to which the EEC originally sent service provisioning request;
forwarding the service provisioning request of EEC1 to ECSn via ECS1, wherein the ECSn sends suitable EDN information to EEC1 via EDGE 4;
transferring EEC to a suitable ECS, the EEC sends request to suitable EES within the EDN info provided by ECS via EDGE 1; and
registering EEC onto the EES, and the EEC sends EAS discovery request, if successful it is followed by QoS session and finally EEC is able to establish data traffic with suitable EAS to serve the needs of user application.

6. The method of claim 5, further comprising determining the list of all the available ECS of ECSP's.

7. The method of claim 5, wherein the target ECS is selected based on the services required for client application.

8. The method of claim 5, further comprising obtaining the IP address of the selected ECS.
